(19) United States
(12) Patent Application Publication
(10) Pub. No.: US 2012/0158523 A1
(43) Pub. Date: Jun. 21, 2012

(54) Online order, fulfillment, and payment distribution system where a product or service is sold to a customer or end user, and a portion of that sale's revenue or profit is distributed to an independent third party not involved in the sale or fulfillment of the order

(76) Inventors: Jason Michael Polstein, Orlando, FL (US); Matthew Evan Polstein, Winter Park, FL (US); Michael Allan Polstein, Miami, FL (US)

(21) Appl. No.: 12/970,442

(22) Filed: Dec. 16, 2010

(51) Int. Cl. G06Q 30/00; G06Q 40/00

(52) U.S. Cl. 705/14.73; 705/39

(57) ABSTRACT

An online order, fulfillment, and payment distribution system where a product or service is sold to a customer or end user, and a portion of that sale's revenue or profit is distributed to an independent third party not involved in the sale or fulfillment of the order. The order, fulfillment, and distribution system comprises of a method for distributing the profit or revenue of a sale to an independent third party, and an optional method for distributing the third parties' literature to a customer or end user.

An online order, fulfillment, and payment distribution system where a product or service is sold to a customer or end user, and a portion of that sale's revenue or profit is distributed to an independent third party not involved in the sale or fulfillment of the order.

### FIELD OF THE INVENTION

The present invention generally relates to online order, fulfillment, and payment distribution system. The invention relates more specifically to a system of distributing revenue or profit from the online sale of a product or service by the manufacturer, distributer, or service provider to an independent third party.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

The development of online stores as a medium for sales and fulfillment of a product or service has made it easier for manufacturers and service providers to sell direct to customers bypassing the traditional channels where manufactures and service providers provide products and services through third party distributers and retailers. The current online sales and fulfillment method where a manufacturer or service provider sells direct to the end user results in channel conflict for the manufacturer or service provider and their distributers and retailers.

Currently there are order and fulfillment systems in use where an order from the end user is placed online through the manufacturer or service provider and the order is either sent to an authorized retailer to fulfill, or placed in a queue where those orders can be selected by and fulfilled by an authorized retailer. For example, Shopatron Inc. of San Luis Obispo, Calif. provides a method where an end user places an order through the manufacturer's or service provider's website and that order is placed in an exchange where a retailer can request to fulfill the order. If they are the closest stocking retailer, they are assigned the order for in-store pickup or shipment to the customer. Shopatron Inc. then pays the retailers for all orders served 2× per month. However, this method of order and fulfillment does not allow the manufacturer or service provider direct control over the speed and quality of delivery. This method can also create confusion for the customer when a breakdown of the fulfillment of the order occurs. Often times, customers will assume that the manufacturer or service provider was at fault for the breakdown in the fulfillment process since the order was placed through the manufacturer's or service provider's website. This assumption can damage the reputation of the manufacturer or service provider.

Online order, fulfillment, and payment distribution systems that distribute payment to a third party are used in several business contexts. For example, in the context of driving traffic to an online store, a portion of a sale can be distributed to an individual or company that drove the traffic to the online store. Typically these individuals or companies are known as referral or affiliate sites, and the payment they receive is based on the traffic and sell through they generate. For example, Amazon.com, Inc. of Seattle, Wash. offers an affiliate program for individuals and companies to receive payment for driving traffic and sales to Amazon.com. In this scenario, the order is placed at Amazon.com, Amazon.com takes payment, and Amazon.com fulfills the order or notifies a third party (sometimes the manufacturer) to fulfill the order. Amazon.com then distributes a payment to the referrer or affiliate.

Based on the foregoing, there is a clear need for a way for manufactures and service providers to receive and fulfill orders from end users without causing channel conflict with other distribution methods. There is also a clear need for a method for manufacturers and service providers to have control over the speed and quality of fulfillment to ensure a positive experience by the end user or customer. Finally, there is also a clear need for a method where the revenue or profit from an online sale generated from an end user or customer using the manufacturer's or service provider's online store can be shared with an independent distributer or retailer authorized to sell products or services by that manufacturer or service provider.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an overview of the online order, fulfillment and payment distribution method described.

FIG. 2 is an overview of

FIG. 3 is an overview of

### DETAILED DESCRIPTION OF THE PREFERRED EMBODIMENT

A method for an online order fulfillment and payment distribution system is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:

1.0 Definition of Terms
2.0 General Overview
3.0 Online Order Fulfillment, Payment Distribution
4.0 Overview of Exchange Between Manufacturer and Retailer
5.0 Overview of Retailer List and Selection
6.0 Extensions and Alternatives

### 1.0 DEFINITION OF TERMS

As used herein, term “product” refers to any commercial goods or services that can be sold to a customer. The term “customer” refers to any end user of a product. The term “manufacturer” refers to any manufacturer, service provider, or distributer who distributes product to independent 3^{rd} parties with the goal of having that product sold to a customer. The term “retailer” refers to any company or individual that is independent to the manufacturer and sells product to a customer. The term “literature” refers to any text, photo, map, advertising material, or coupon.

### 2.0 GENERAL OVERVIEW

The needs identified in the foregoing Background, and other needs and methods that will become apparent for the following description, are achieved in the present invention, which comprises, in one aspect, a method for payment distribution from a manufacturer to an eligible retailer who did not participate in the sale from the manufacturer to the customer. The method comprises of a list of eligible retailers, a system for selecting a retailer to distribute payment to, and a system for the retailer to include literature and/or advertising material to a customer receiving an order from the manufacturer.

Other aspects will become apparent from the following description.

### 3.0 ONLINE ORDER, FULFILLMENT, PAYMENT DISTRIBUTION

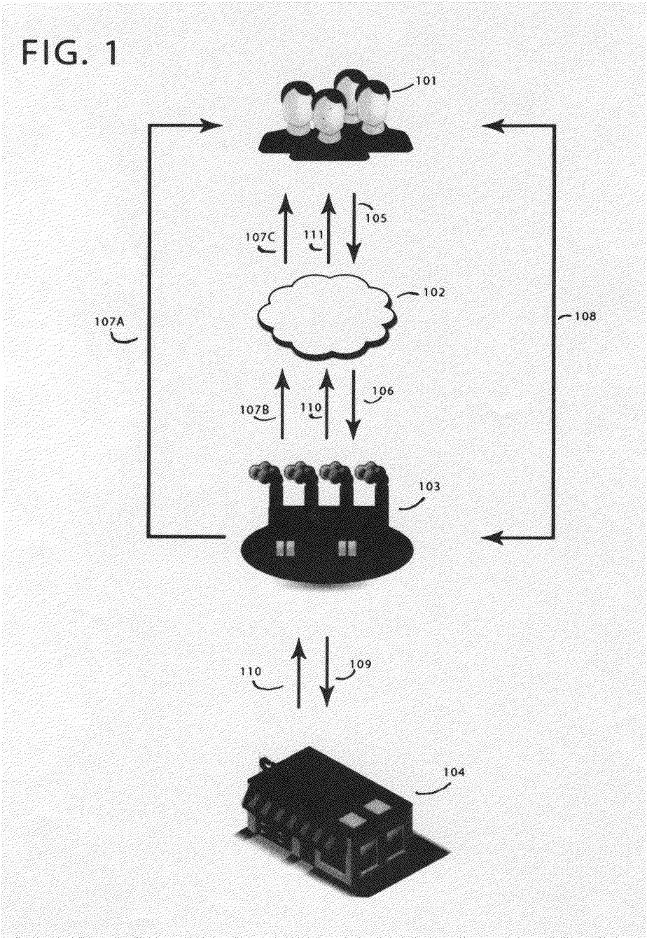

FIG. 1 is a block diagram 100 that illustrates an approach for a customer 101 placing an order for and paying 105 for one or more products with a manufacturer 103, the manufacturer 103 fulfilling 107A or 107B/107C that order to the customer 101, and the manufacturer 103 distributing payment 109 to a retailer 104.

According to one embodiment, a customer 101 places an order for and pays 105 for one or more products from a manufacturer 103 over a link 102. Link 102 may be any medium for transferring data between customer 101 and manufacturer 103 and the invention is not limited to any particular medium. Examples of the link 102 include, without limitation, a network such as a LAN, WAN, or the Internet, a telecommunications link, a wire or optical link or a wireless connection.

The manufacturer 103 receives the order 106 from the customer 101 through the link 102. The manufacturer 103 may optionally reply 110 to the customer 101 through the link 102. Examples of the reply 110 include, without limitation, acknowledgment of receiving the order 106, estimated shipping date of the order 106, and shipment-tracking information of the order 106.

The customer 101, receives communication 111 from manufacturer 103 through the link 102.

The received order 106 is processed and fulfilled 107A by the manufacturer 103 to the customer 101. Fulfillment 107A describes delivery to customer 101 through a traditional delivery method. Examples of a traditional delivery method include, without limitation, a truck, a van, a car, or a plane. Additional electronic methods could include, but are not limited by fulfillment 107B/107C through the link 102.

Once an order 106 has been fulfilled 107A or 107B/107C the manufacturer 103 distributes a payment or credit 109 to a retailer 104 based on the retailer 104 meeting a certain requirement. Examples of a requirement include, without limitation, physical distance between customer 101 and retailer 104 and the amount of business the retailer 104 generates for the manufacturer 103. It should be noted that the requirement could be obtained by combining one or more attributes. It should also be noted that the payment 109 from manufacturer 103 to retailer 104 could be split between one or more retailers 104, using multiple methods to define the share of the payment 109. Examples of share of the payment 109 include, without limitation, physical distance between customer 101 and retailer 104 and the amount of business the retailer 104 generates for the manufacturer 103.

The retailer 104 provides the manufacturer 103 literature 110 that is included with the fulfillment 107A or 107B/107C of the order 106 from the manufacturer 103 to the customer 101. It should be noted that the literature 110 can be provided to the customer 101 using a separate method than the order 106 fulfillment method 107A or 107B/107C. It should also be noted that the literature 110 can be optional and the payment 109 is not dependent on literature 110 being provided by the retailer 104.

### 4.0 OVERVIEW OF EXCHANGE BETWEEN MANUFACTURER AND RETAILER

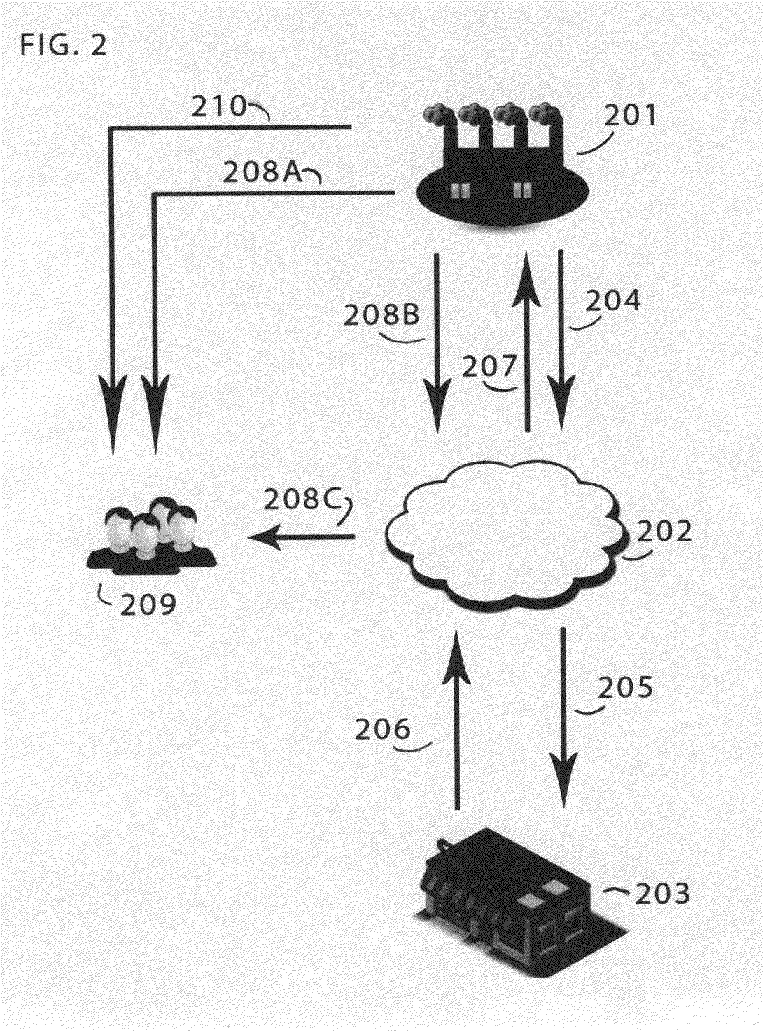

FIG. 2. is a block diagram 200 that illustrates an approach for a manufacturer to make a payment to a selected retailer. Its purpose is to give a more detailed description of the exchange process described in FIG. 1.

The manufacturer 201 sends a payment/credit 204 to the retailer 203 through the link 202. The link 102 may be any medium for transferring a payment/credit between manufacturer 201 and retailer 203 and the invention is not limited to any particular medium. Examples of the link 202 include, without limitation, the United States Postal Service, any other mail service provider, electronic transfer, a network such as a LAN, WAN, or the Internet, a telecommunications link, a wire or optical link or a wireless connection.

The retailer 203 receives the payment/credit 205 from the manufacturer 201 through the link 202.

The retailer 203 sends literature 206 to the manufacturer 201 through the link 202. The manufacturer 201 receives the literature 207 from the retailer 203 through the link 202. The manufacturer 201 provides literature 208A/208B/208C to customer 209 through traditional delivery/shipping methods (208A) or through the link 202 (208B/208C). It is important to note this invention provides for the ability to deliver the literature 208A with the customer's order 210 that was placed with the manufacturer 201.

### 5.0 OVERVIEW OF RETAILER LIST, LITERATURE, AND SELECTION PROCESS

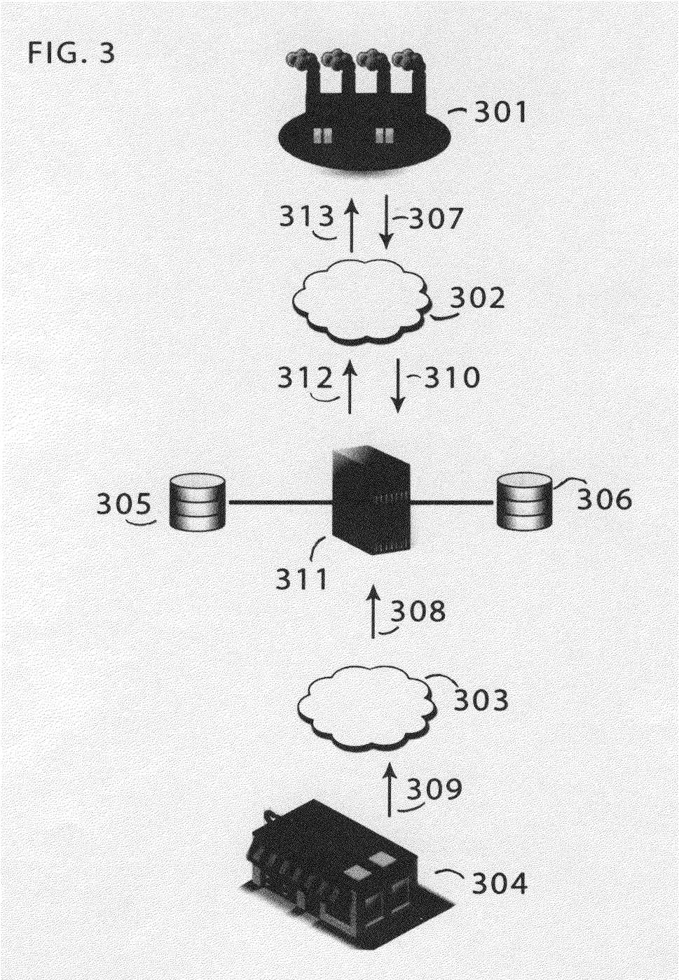

FIG. 3. is a block diagram 300 that illustrates an approach for storing and retrieving one or more retailers as well as zero or more literature. Its purpose is to give a more detailed description of the process for selecting a retailer for payment/credit.

Manufacturer 301 sends customer order data 307 to a device 311 through a link 302. Examples of the device 311 include, without limitation a server or other type of computer system designed to store and retrieve data. The device 311 receives the customer order data 310 from the link 302. The device 311 then pulls information 305 about one or more retailers that meet a specific predefined condition. Examples of a predefined condition include, without limitation the physical distance from the customer to the retailer, some other geographical condition, and/or the amount of business a retailer 304 does with the manufacturer 301. After the selection of one or more retailers, the device 311 pulls literature related to the corresponding retailer 306.

The device 311 sends the retrieved retailer information and any literature 312 through the link 302. The manufacturer receives retailer information and any literature 313 from the link 302.

It should be noted that both the retailer information 305 and the corresponding literature 306 could be held in a database or any other method used for storing and retrieving information electronically. It should also be noted that the device 311, the retailer information 305, and the corresponding literature 306 could be physically located at a location that includes, without limitation an office of the manufacturer 301, a warehouse of the manufacturer 301, or a server room of the manufacturer 301. Finally, it should also be noted that the device 311, the retailer information 305, and the corresponding literature 306 could be located outside of the manufacturer 301. Examples of being located outside the manufacturer 301 include, without limitation the Internet, World Wide Web, or any other public or private network.

The retailer 304 can upload literature 309 through the link 303 for literature storage 306 through the device 311. The uploaded literature 309 is stored in a way that it corresponds with the specific retailer information 305. One example of this includes, without limitation, a shared key.

### 6.0 EXTENSIONS AND ALTERNATIVES

In the foregoing specification, the invention has been described with reverence to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A computer-implemented method for distributing payment from manufacturer to retailer, the method comprising:
providing electronic digital information that causes one or more attributes of one or more retailers to be displayed;
establishing, in electronic digital form, from electronic digital information received over the Internet, LAN, or WAN, a retailer associated with a customer's order placed with and fulfilled by the manufacturer.
causing to be delivered from the manufacturer to the retailer a payment or credit.

2. A computer-implemented method for distributing literature from a retailer to a customer, in the method comprising:
providing electronic digital information that causes one or more attributes of literature from a retailer to be displayed;
establishing, in electronic digital form, from electronic digital information received over the Internet, LAN, or WAN a customer's order that is linked with the retailer's literature
causing the retailer's literature to be delivered with, or separate from, the customer's order.
